(19) United States
(12) Patent Application Publication
(10) Pub. No.: US 2022/0393454 A1
(43) Pub. Date: Dec. 8, 2022

(54) CABLE CARRIER ELEMENT

(71) Applicant: HEWLETT-PACKARD DEVELOPMENT COMPANY, L.P., Spring, TX (US)

(72) Inventors: Agusti Garcia Pujol, Sant Cugat del Valles (ES); Oscar Lopez Lopez, Sant Cugat del Valles (ES); Pedro Luis Las Heras Sanz, Sant Cugat del Valles (ES); Marc Guillaumet Campmany, Sant Cugat del Valles (ES); Marc Deiros Llinas del Torrent, Sant Cugat del Valles (ES)

(73) Assignee: HEWLETT-PACKARD DEVELOPMENT COMPANY, L.P., Spring, TX (US)

(21) Appl. No.: 17/774,110

(22) PCT Filed: Jan. 28, 2020
(86) PCT No.: PCT/US2020/015404

§ 371 Date: May 3, 2022

(51) Int. Cl. H02G 11/00; F16G 13/16

(52) U.S. Cl. CPC H02G 11/006; F16G 13/16

(57) ABSTRACT

Disclosed herein is an element for a cable carrier, a printing device and a method assembling a cable carrier from segments. The cable carrier element comprises a frame surrounding an opening that is to receive a cable or a tube, or a bundle of cables or tubes. The frame comprises four frame members, wherein pairs of adjacent frame members form U-shaped portions of the frame. A right-hand side U-shaped portion is adjustably engaged with a left-hand side U-shaped portion such that the respective U-shaped portions are movable relative to each other along a first direction to vary a cross-sectional area of the opening. A bottom U-shaped portion is adjustably engaged with a top U-shaped portion such that the respective U-shaped portions are movable relative to each other along a second direction perpendicular to the first direction to vary the cross-sectional area of the opening.

### BACKGROUND

A cable carrier may be used to guide and protect flexible elements such as cables and tubes that are attached to a movable object, for example a print head carriage in a printing device. The cable carrier may comprise a hollow core, in which the cables and tubes may be arranged. The cable carrier may be formed from a plurality of linked segments, wherein adjacent segments are linked such that the segments can pivot relative to one another, thereby allowing the cable carrier to bend when the object moves.

### BRIEF DESCRIPTION OF DRAWINGS

In the following, a detailed description of various examples is given with reference to the figures. The figures show schematic illustrations of

FIG. 1a: an element for a cable carrier according to an example in a cross-sectional side view;

FIG. 1b: the cable carrier element of FIG. 1a in an extended state in accordance with an example;

FIG. 2a: an element for a cable carrier comprising clipping members according to an example in a perspective view;

FIG. 2b: the cable carrier element of FIG. 2a in a disassembled state in accordance with an example;

FIG. 2c: a left-hand side frame member and a right-hand side frame member of the cable carrier element of FIG. 2a according to an example in top view;

FIG. 3: a printing device in accordance with an example in top view;

FIG. 4: a method of assembling a cable carrier from segments according to an example;

FIG. 5a: a segment for a cable carrier to be assembled using the method of FIG. 4 in accordance with an example in a cross-sectional side view;

FIG. 5b: the segment of FIG. 5a in top view according to an example; and

FIG. 6: a method of assembling a cable carrier from segments according to an example.

### DETAILED DESCRIPTION

An element for a cable carrier, a printing device and a method of assembling a cable carrier from segments are described below with reference to some examples shown in the drawings. A cable carrier may comprise a plurality of elements or segments that are linked to each other to form a chain. Each of the elements may comprise a frame that surrounds an opening such that the cable carrier forms a channel or hollow core, in which a flexible object such as a cable or a tube, or a bundle of cables or tubes, or a combination thereof, may be arranged. To prevent movement and/or bending of the flexible object, the size of the opening of the elements may be chosen based on the number and/or size of the objects to be arranged in the cable carrier. If the elements have a fixed size, different types of elements may be needed for different applications, e.g. in different printer models. This may complicate logistics and may increase costs for manufacturing and providing spare parts.

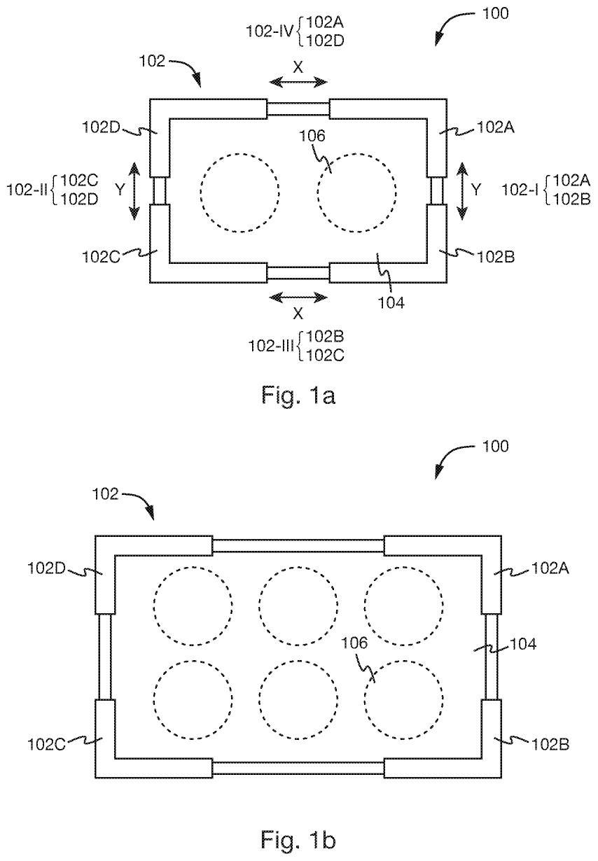

FIG. 1 shows a schematic illustration of an element 100 for a cable carrier in a cross-sectional side view. The element 100 comprises a frame 102 that surrounds an opening 104. The opening 104 is to receive a cable or a tube, or a bundle of cables and/or tubes, 106, e.g. a cable connecting a print head mounted in a movable print head carriage to a controller in a printing device or a tube connecting the print head to a reservoir storing a printing fluid such as ink. The frame 102 may for example comprise a polymer material such as polyvinyl chloride, polypropylene, polyamide and/or polyester. Additionally or alternatively, the frame 102 or a part thereof may comprise metal, e.g. aluminum.

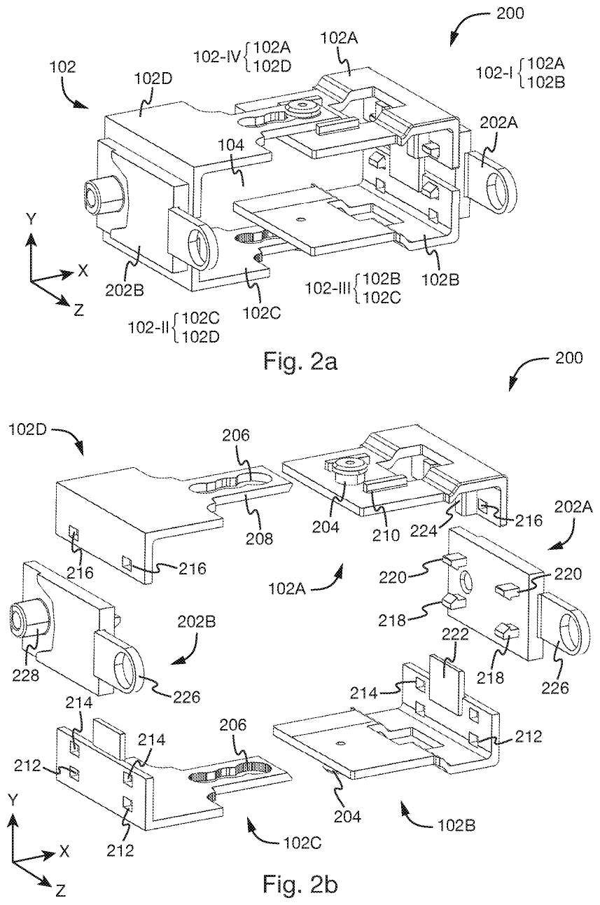

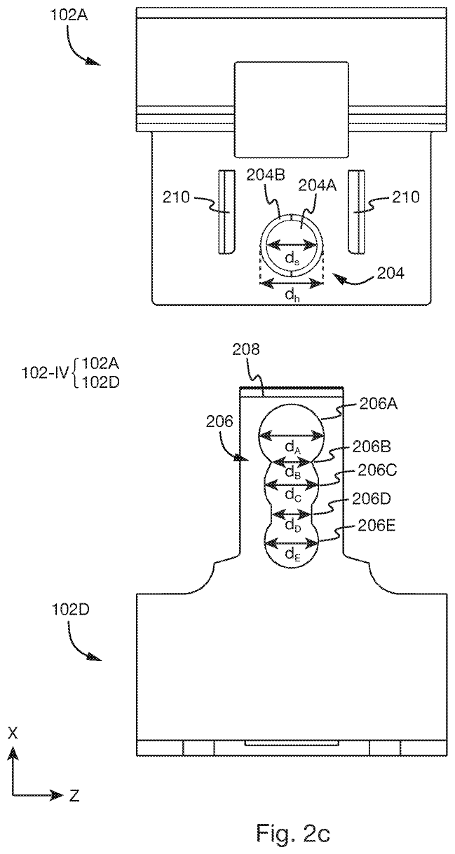

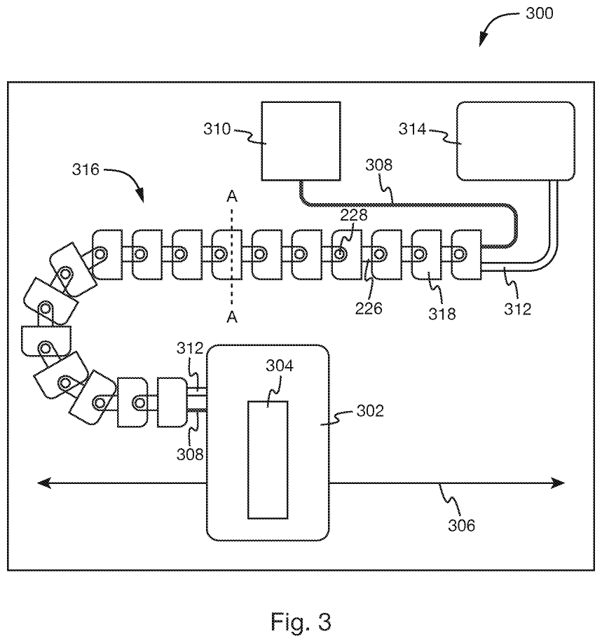

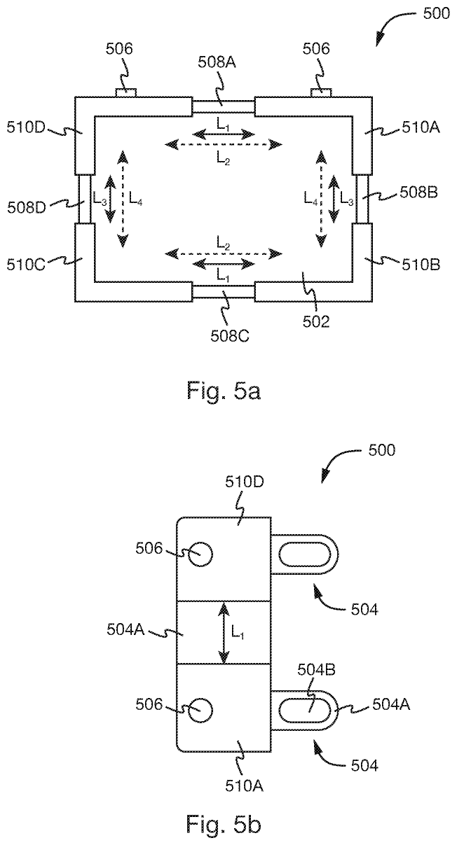

The element 100 may further comprise a proximal connector and a distal connector (not shown) for linking the element 100 to adjacent elements to assemble the cable carrier, e.g. similar to the cable carrier element 200 of FIGS. 2a-2c or to the cable carrier segment 500 of FIG. 5, described below. Accordingly, the element 100 may form a segment of an assembled carrier, e.g. as detailed below with reference to FIG. 3. In the context of this disclosure, a cable carrier element such as the element 100 may thus also be referred to as a segment or cable carrier segment, in particular when the element is assembled into a cable carrier.

The frame 102 of this example comprises four frame member 102A, 102B, 102C and 102D. Each of the frame members 102A-102D may e.g. have an L-shape as shown in FIG. 1a. In other examples, corners of the frame members 102-A-102D may e.g. be rounded and/or legs of the frame members may not be perpendicular to each other. Pairs of adjacent frame members form U-shaped portions of the frame 102. The frame members 102A, 102B form a right-hand side U-shaped portion 102-I and the frame members 102C, 102D form a left-hand side U-shaped portion 102-II. The frame members 102B, 102C form a bottom U-shaped portion 102-III and the frame members 102A, 102D form a top U-shaped portion 102-IV. In the context of this disclosure, the terms “left”, “right”, “bottom”, “top”, “proximal” and “distal” are used to simplify the description of the spatial relationship of objects to each other, as illustrated in the drawings. This, however, does not imply a certain orientation of the element 100 or other objects described herein. Depending on the orientation of the respective object and the view point of an observer, the actual spatial relationship may be different and may e.g. be rotated by 90° or may be mirrored in some examples.

The right-hand side U-shaped portion 102-I is adjustably engaged with the left-hand side U-shaped portion 102-II such that the respective portions are movable relative to each other along a first direction as indicated by the horizontal arrows labeled with “X” in FIG. 1a. Furthermore, the bottom U-shaped portion 102-III is adjustably engaged with the top U-shaped portion 102-IV such that the respective portions are movable relative to each other along a second direction perpendicular to the first direction as indicated by the vertical arrows labeled with “Y” in FIG. 1a. In the following, the first and second directions may also be referred to as the X direction and Y direction, respectively. The direction perpendicular to the first and second directions may also be referred to as the Z direction. In some examples, the respective portions may be adjustably engaged via an extendable member disposed therebetween, e.g. similar to the cable carrier segment 500 of FIGS. 5a, 5b described below.

By moving the corresponding portions of the frame 102, a cross-sectional area of the opening 104 may be varied. A width of the opening 104 along the first direction may for example be increased or decreased by moving the right-hand side portion 102-I relative to the left-hand side portion 102-II. A height of the opening 104 along the second direction may for example be increased or decreased by moving the bottom portion 102-III relative to the top portion 102-IV. FIG. 1b depicts the element 100 in an extended state, in which the cross-sectional area of the opening 104 has been increased as compared a non-extended or compressed state as shown to FIG. 1a. This may allow for arranging a different number of objects and/or objects of a different size in the opening 104, e.g. two cables or tubes 106 in the example of FIG. 1a and six cables or tubes 106 in the example of FIG. 1b. The cross-sectional area of the opening 104 in the extended state may for example be between two times and ten times larger than in the compressed state.

FIG. 2a shows a schematic illustration of an element 200 for a cable carrier according to another example in a perspective view. The element 200 may be functionally similar to the element 100 of FIG. 1a and also comprises a frame 102 that surrounds an opening 104 and comprises four frame members 102A-102D. The element 200 may further comprise a right-hand side clipping member 202A and a left-hand side clipping member 202B. In FIG. 2b, the element 200 is depicted in a disassembled state prior to connecting the members 102A-102D, 202A-202B to each other. FIG. 2c illustrates the two frame members 102A, 102D forming the top U-shaped portion 102-IV of the frame 102 in top view in the disassembled state.

In some examples, one or each of the frame members 102A, 102B of the right-hand side portion 102-I may comprise a pin 204. The pin 204 may e.g. protrude from a bottom or top surface of the respective frame member 102A, 102B, for example a surface perpendicular to the Y direction in FIG. 2b. One or each of the frame members 102C, 102D of the left-hand side portion 102-II may comprise a slot or cutout 206 that extends along the first direction, which corresponds to the X direction in FIG. 2a. The slot 206 is to receive the pin 204 of the respective frame member of the right-hand side portion 102-I. Such a slot/pin arrangement constitutes one example how individual members 102A-102D and/or portions 102-I to 102-IV of the frame 102 can be adjustably engaged. In the example of FIG. 2a, the right-hand side portion 102-I can be moved relative to the left-hand side portion 102-II along the X direction by sliding the pins 204 along the slots 206. In some examples, one or both frame members 102B, 102C of the bottom portion 102-III may also be adjustably engaged with the respective frame member 102A, 102D of the top portion 102-IV via a corresponding slot/pin arrangement.

In some examples, at least one of the frame members 102A-102D comprises a guiding rail that extends along the X direction and is to receive a guiding protrusion of one of the other frame members 102A-102D. The slot 206 may for example be arranged in a guiding protrusion 208 extending along the X direction from a main body of the respective frame member 102C, 102D. The frame members 102A, 102B may comprise a corresponding guiding rail 210 that is to receive and confine the respective guiding protrusion 208. In the example of FIG. 2a, the guiding rail 210 comprises a pair of protrusions on the main body of the respective frame member 102A, 102B that are to prevent travel of the guiding protrusion 208 in one or both directions perpendicular to the X direction, while allowing the guiding protrusion 208 to slide along the X direction. In other examples, each of the pins 204 may be arranged on a guiding protrusion similar to the guiding protrusion 208 shown in FIG. 2a and each of the slots 206 may be adjacent to a guiding rail similar to the guiding rail 210 of FIG. 2a, wherein the guiding rail may e.g. be a pair of protrusions arranged on opposite sides of the slot 206.

In some examples, one or each of the pins 204 may comprise a shaft portion 204A and a head portion 204B, wherein the shaft portion 204A is arranged between the head portion 204B and the main body of the respective frame member 102A, 102B. The shaft portion 204A may have a shaft diameter dₛ and the head portion 204B may have a head diameter dₕ that is larger than the shaft diameter dₛ, e.g. as illustrated in FIGS. 2b, 2c. In one example, the head diameter dₕ may e.g. be between 10% and 50% larger than the shaft diameter dₛ.

In some examples, one or each of the slots 206 may comprise an insertion portion 206A, wherein a width d_{A} of the insertion portion 206A is larger than the head diameter dₕ such that the pin 204 can be inserted into or removed from the slot 206 via the insertion portion 206A. One or each of the slots 206 may further comprise two or more holding portions 206C, 206E, wherein a width d_{C}, d_{E} of the holding portion 206C, 206E, respectively, is equal to or larger than the shaft diameter dₛ, but smaller than the head diameter dₕ. In this way, the shaft portion 204A of the pin 204 may be arranged in one of the holding portions 206C, 206E while the head portion 204A prevents the pin 204 from falling or sliding out of the slot 206.

The holding portions 206C, 206E may be separated from each other and/or from the insertion portion 206A by throat portions or intermediate portions 206B, 206D, i.e. the insertion portion 206A, the intermediate portion 206B, the holding portions 206C, the intermediate portion 206D and the holding portion 206E may e.g. be arranged adjacent to each other along the X direction as illustrated in FIG. 2c. A width d_{B}, d_{D} of the first and second intermediate portion 206B, 206D, respectively, is smaller than the shaft diameter dₛ. Accordingly, the intermediate portions 206B, 206D may prevent the pin 204 from leaving the holding portion 206C or 206E. The guiding protrusion 208 and/or the shaft portion 204A may comprise a flexible material, e.g. a flexible plastic. This may allow for moving the pin 204 through an intermediate portion 206B, 206D by applying a sufficiently large force, e.g. a force larger than a threshold force, wherein the threshold force may for example be between 1 N to 10 N. Thereby, the pin 204 may be inserted into the slot 208, moved to one of the holding positions 206C, 206E and fixed at one of the holding positions 206C, 206E without using a tool. In some examples, the slot 206 may comprise a larger number of holding portions, e.g. between three and ten holding portions, each of which may be separated from adjacent holding portions by corresponding intermediate portions.

In another example, the slot 206 or a part thereof may have a substantially uniform width. To fix the pin 204 in the slot 206, the pin 204 may e.g. comprise a screw which may be screwed into the shaft portion 204A or the main body of the respective frame member 102A, 102B or a clipping hook or fastener that is to be attached to the shaft portion 204A or the main body of the respective frame member 102A, 102B.

In some examples, one or each of the frame members 102B, 102C of the bottom U-shaped portion 102-III comprises two holes 212, 214 that are displaced from each other along the second direction or Y direction. One or each of the frame members 102A, 102D of the top portion 102-IV may comprise a hole 216. Each of the holes 212, 214, 216 may be to receive a clipping pin or clipping hook. This allows for fixing the bottom portion 102-III and the top portion 102-IV of the frame 102 at two different positions with respect to each other along the Y direction, e.g. by inserting a clipping pin into the hole 216 and into one of the holes 212, 214. Each of the holes 212, 214, 216 may for example extend through a side wall of the respective frame member that is perpendicular to the X direction as shown in FIG. 2b. In some examples, the frame members 102B, 102C of the bottom portion 102-III and/or the frame members 102A, 102D of the top portion 102-IV may comprise a larger number of holes, e.g. between three and ten holes.

In some examples, the element 200 may comprise a right-hand side clipping member 202A and a left-hand side clipping member 202B, each of which may comprise a bottom clipping pin 218 and a top clipping pin 220. The bottom clipping pin 218 is to be inserted into one of the holes 212, 214 of one of the frame members 102B, 102C of the bottom portion 102-III of the frame 102 and the top clipping pin 220 is to be inserted into the hole 216 of one of the frame members 102A, 102D of the top portion 102-IV of the frame 102.

In one example, one or each of the holes 212, 214, 216 may be a pair of holes that are displaced from each other along the Z direction as illustrated in FIG. 2b. Accordingly, one or each of the bottom and top clipping pins 218, 220 may be a pair of clipping pins that are displaced from each other along the Z direction and are to be inserted into a respective pair of holes. The top pair of clipping pins 220 may e.g. be inserted into the pair of holes 216 of the respective frame member 102A, 102D of the top portion 102-IV and the bottom pair of clipping pins 218 may e.g. be inserted into one of the pairs of holes 212, 214 of the respective frame member 102B, 102C of the bottom portion 102-III as illustrated in FIGS. 2a, 2b. Thereby, a pivoting motion of the frame members 102A, 102D of the top portion 102-IV relative to the frame members 102B, 102C of the bottom portion 102-III may be prevented, which may increase the stability of the element 200.

In some examples, at least one of the frame members 102A-102D may comprise a guiding rail that extends along the Y direction and is to receive a guiding protrusion of one of the other frame members 102A-102D. For example, one or each of the frame members 102B, 102C of the bottom portion 102-III may comprise a guiding protrusion 222 that extends from a main body of the respective frame member 102B, 102C along the Y direction. One or each of the frame members 102A, 102D of the top portion 102-IV may comprise a guiding rail 224 that extends along the Y direction and is to receive the guiding protrusion 222 of the corresponding frame member 102B, 102C. The guiding rail 224 may e.g. be similar to the guiding rail 210.

The element 200 may further comprise a proximal connector 226 and a distal connector 228. For assembling the cable carrier, the proximal connector 226 is to be connected to a distal connector of a proximally adjacent cable carrier element and the distal connector 228 is to be connected to a proximal connector of a distally adjacent cable carrier element, e.g. as described below with reference to FIG. 3. Each of the proximally and distally adjacent elements may e.g. be similar or identical to the element 200. The proximal and distal connectors 226, 228 are to be connected such that adjacent elements of the cable carrier can pivot relative to each other around at least one axis, e.g. the X axis of FIG. 2a.

In the example of FIG. 2a, the proximal and distal connectors 226, 228 are part of the clipping members 202A, 202B. The proximal connector 226 comprises a cutout or a recess in one or each of the left-hand and right-hand side clipping members 202A, 202B, e.g. in a protrusion extending along the Z direction from a main body of the respective clipping member 202A, 202B. The distal connector 228 comprises a pin or a protrusion, referred to as a connector pin in the following, in one or each of the left-hand and right-hand side clipping members 202A, 202B. The connector pin is to be inserted into the cutout or recess of the respective clipping member of an adjacent element to connect the element 200 with the adjacent element.

FIG. 3 depicts a printing device 300 according to an example in top view. The printing device 300 may for example be a 2D printing device that is to deposit a printing fluid on a print medium, e.g. a large format ink-jet printer. In other examples, the printing device 300 may for example be a 3D printing device, e.g. a 3D printer that is to deposit a binding agent onto a bed of build material.

The printing device 300 comprises a movable carriage that is to be moved along at least one direction. The movable carriage may for example be a print head carriage 302 that is to receive a print head 304, wherein the print head 304 is to deposit a printing fluid such as ink or a binding agent. The print head carriage 302 may for example be movable along a print head path 306 across a print medium (not shown) such as paper. In other examples, the print head carriage 302 may be moveable along two or three directions, e.g. in a 3D printing device.

The printing device 300 further comprises a flexible connecting member, wherein a distal end of the flexible connecting member is attached to the movable carriage. The flexible connecting member may for example be or comprise a cable 308, or a bundle of cables, wherein a distal end of the cable 308 is connected to the print head carriage 302. A proximal end of the cable 308 may e.g. be connected to a controller 310 of the printing device 300 that is to control the print head carriage 302 and/or the print head 304. In other examples, the proximal end of the cable 308 may e.g. be connected to a power supply (not shown) of the printing device 300. In some examples, the flexible member may be or comprise a tube 312, or a bundle of tubes, wherein a distal end of the tube 312 is connected to the print head carriage 302. A proximal end of the tube 312 may for example be connected to a reservoir 314 storing a printing fluid.

The printing device 300 also comprises a cable carrier 316. The cable carrier 316 comprises a plurality of segments 318 that are linked to each other to form a chain of segments. In some examples, each of the segments may be similar to one of the cable carrier elements 100 and 200 as detailed below. Accordingly, a cross-section of a segment along the dashed line A-A in FIG. 3 may e.g. be similar to the cross-section shown in FIG. 1 or to a cross-section parallel to the X-Y plane in FIG. 2a.

Each of the segments 318 may for example comprise a proximal connector 226 and a distal connector 228, which may e.g. be similar to the proximal and distal connectors of the cable carrier element 200. The proximal connector 226 of each segment is connected to the distal connector 228 of a proximally adjacent segment, i.e. the adjacent segment that is farther away from the print head carriage 302. The distal connector 228 of each segment is connected to the proximal connector 226 of a distally adjacent segment, i.e. the adjacent segment that is closer to the print head carriage 302.

Each of the segments 318 may surround an opening, e.g. similar to the opening 104 of the cable carrier element 100 or 200. Accordingly, the chain of segments of the cable carrier 316 has a hollow core, in which the flexible connecting member, e.g. the cable 308 and the tube 312, is arranged. The direction or path along which the hollow core extends is referred to as the longitudinal direction in the context of this disclosure. The proximal and distal connectors 226, 228 are such that adjacent segments 318 may pivot with respect to each other, e.g. around an axis parallel to the direction of view in FIG. 3. The cable carrier 316 may thus be bent as shown in FIG. 3, e.g. when the print head carriage 302 is moved. The longitudinal direction may therefore not be a straight line, but may follow a bent path, i.e. may have a different orientation at each segment 318 as illustrated in FIG. 3. When the cable carrier 316 is bent, adjacent segments 318 may come in contact with each other, which may limit a radius of curvature of the cable carrier 316 and thus of the flexible connecting member arranged therein.

Each of the segments 318 comprises four members that form a frame around the hollow core of the cable carrier 316. Each of the segments 318 is adjustable along a first transverse direction perpendicular to the longitudinal direction by moving a first member and a second member relative to a third member and a fourth member. The second member is adjacent to the first member and the fourth member is adjacent to the third member. Each of the segments 318 is further adjustable along a second transverse direction perpendicular to the longitudinal direction and to the first transverse direction by moving the first member and the fourth member relative to the second member and the third member. The fourth member is adjacent to the first member and the third member is adjacent to the second member.

In some examples, the members of each segment 318 may be similar to the frame members 102A-102D of the cable carrier element 100 or 200. In particular, the first member may e.g. correspond to the frame member 102A, the second member to the frame member 102B, the third member to the frame member 102C and the fourth member to the frame member 102D. In other words, in some examples, the cable carrier 316 may be assembled from elements such as the cable carrier element 100 or 200, i.e. the cable carrier element 100 or 200 may form a segment 318 of the assembled cable carrier 316.

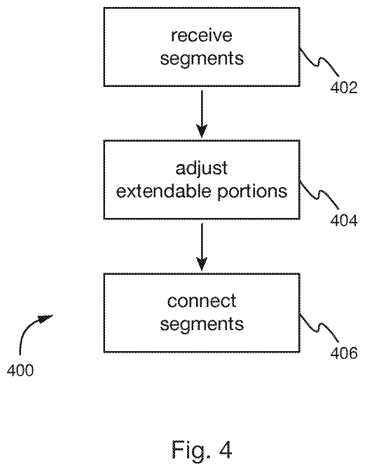

FIG. 4 depicts a flow chart of a method 400 of assembling a cable carrier from segments in accordance with an example. The method 400 may for example be used to assemble the cable carrier 316 of the printing device 300. The method 400 is described in the following using the segment 500 shown in FIGS. 5a, 5b and the cable carrier element 200 of FIGS. 2a-2c as examples for the segments. FIG. 5a depicts a cross-sectional side view of the segment 500 and FIG. 5b a top view. In other examples, the segments of the cable carrier may e.g. be similar to the cable carrier element 100. The method 400 is not limited to the order of execution indicated by the flow chart in FIG. 4. As far as technically feasible, the method 400 may be executed in an arbitrary order and parts thereof may be executed simultaneously at least in part.

Each of the segments 500 of the cable carrier encloses a respective opening 502 and comprises a proximal connecting member 504 and a distal connecting member 506. Each of the segments 500 further comprises four extendable portions 506A, 506B, 506C and 506D that are arranged on four sides of the opening 502. Each of the extendable portions 506A-506D has an adjustable length. Two opposite extendable portions 508A, 508C are to be moved from a first length L₁ to a second length L₂ to adjust a width of the opening 502. The other two opposite extendable portions 508B, 508D are to be moved from a third length L₃ to a fourth length L₄ to adjust a height of the opening. The second length L₂ may for example be between 1.5 times and 10 times the first length L₁ and the fourth length L₄ may for example be between 1.5 times and 10 times the third length L₃. In some examples, the extendable portions 506A-506D may have a continuously adjustable length, which may e.g. be adjusted continuously between a respective minimum length and a respective maximum length. In other examples, the extendable portions 506A-506D may have a stepwise adjustable length, which may e.g. be adjusted to a respective minimum length and a respective maximum length or to a plurality of discrete lengths between the respective minimum and maximum lengths.

In the example of FIG. 5a, 5b, the segment 500 is similar to the cable carrier element 100 of FIG. 1a. The segment 500 comprises four frame members 510A, 510B, 510C and 510D, which may e.g. be similar to the frame members 102A-102D described above. Each of the extendable portions 508A-508D is arranged between respective two of the frame members 510A-510D. Accordingly, the frame members 510A-510D may be moved relative to each other by adjusting the length of the extendable portions 508A-508D. In some examples, the extendable portions 508A-508D may be formed by the corresponding frame members 510A-510D, i.e. the extendable portions 508A-508D may comprise the corresponding frame members 510A-510D or a part thereof. An extendable portion may for example comprise a cutout or slot in a first one of the frame members 510A-510D and a pin on a second one of the frame members 510A-510D, e.g. as described above with reference to FIGS. 2a-2c. Alternatively, an extendable portion may comprise holes in the adjacent frame members and a fastening clip or clipping member, e.g. as described above with reference to FIGS. 2a-2c. In other examples, an extendable portion may e.g. comprise a piston that is movable in a surrounding cylinder.

In the example of FIG. 5a, 5b, the proximal connecting member 504 comprises a pair of protrusions 504A, each of which comprises a longitudinal slot or opening 504B. The protrusions 504A may e.g. be attached to or part of the frame members 510A and 510D. The distal connecting member 506 comprises a pair of connector pins 506, which may e.g. also be attached to or part of frame members 510A and 510D. The connector pins 506 are to be inserted into a slot 504B of the distal connecting member of an adjacent element and may e.g. comprise a widened head portion similar to the pins 204 shown in FIG. 2c to prevent the connector pins 506 from falling or sliding out of the slot 504B of the distal connecting member. The slots 504B are elongated in one direction, thereby allowing the connector pins 506 to move within the slots 504B such that adjacent segments 500 can pivot with respect to each other. In some examples, the proximal and distal connecting members 504, 506 may also comprise corresponding structures on the frame members 510B, 510C. In other examples, the proximal and distal connecting member of the segment 500 may e.g. be similar to the proximal and distal connecting member 226, 228 of the cable carrier element 200.

The method 400 comprises, in block 402, receiving a first segment and a second segment. Each of the first and second segments may e.g. be similar to the segment 500 and/or to one of the cable carrier elements 100, 200. The first and second segments may e.g. be received in an assembled state, in which the corresponding members are connected to each other. In other examples, the first and second segments may be received in a partially assembled state or in a disassembled state, e.g. as described below.

The method 400 further comprises, for each of the first and second segments, adjusting the width and the height of the respective opening 502 to a final configuration at block 404. The width and the height of the opening 502 are adjusted by adjusting the respective extendable portions 508A-508D. The width and height of the opening 502 in the final configuration are chosen based on a cross-sectional area of objects to be arranged in the cable carrier. The final configuration may be the same for the first and second segments, i.e. the openings 502 of the first and second segments may have the same size in the final configuration. The cross-sectional area of the objects may e.g. be characterized by a number and/or a size of the objects to be arranged in the cable carrier. In one example, a final configuration with a smaller width and/or height may be chosen in case a smaller number of objects is to be arranged in the cable carrier, e.g. one or two cables, and a final configuration with a larger width and/or height may be chosen in case a larger number of objects is to be arranged in the cable carrier, e.g. between ten and twenty cables.

In some examples, one or each of the extendable portions 508A, 508C of the segments for adjusting the width and/or one or each of the extendable portions 508B, 508D of the segments for adjusting the height may comprise a frame member having a pin and a frame member having a longitudinal cutout or slot that is to movably receive the pin. The frame member with the pin may e.g. be similar to one of the frame members 102A, 102B of FIG. 2c and the frame member with the cutout may e.g. be similar to one of the frame members 102C, 102D of FIG. 2c. Adjusting the width and/or height of the openings 502 of the first and second segments may comprise moving the respective pins 204 along the cutouts 206, e.g. to first holding portion 206C or to the second holding portion 206E. In some examples, the method may further comprise assembling each of the first and second segments by inserting the pins 204 into the respective cutouts 206, e.g. via the insertion portion 206A.

In some examples, one or each of the extendable portions 508A, 508C of the segments for adjusting the width and/or one or each of the extendable portions 508B, 508D of the segments for adjusting the height may comprise a base frame member having two holes and a movable frame member having one hole. The base frame member may for example be similar to one of the frame members 102B, 102C of FIG. 2b and the movable frame member may for example be similar to one of the frame members 102A, 102D of FIG. 2b. In some examples, a fastening clip comprising clipping pins may be used for fixing an extendable portion at a desired length, e.g. a fastening clip similar to one of the clipping members 202A, 202B of FIG. 2b.

Adjusting the height and/or width of the openings 502 of the first and second segments may comprise, for each of the respective extendable portions 508A-508D, moving the movable frame member 102A, 102D relative to the base frame member 102B, 102C, e.g. along the X or Y direction of FIG. 2b. Adjusting the height and/or width of the openings 502 of the first and second segments may further comprise, for each of the respective extendable portions 508A-508, attaching a fastening clip or clipping member 202A, 202B to the respective extendable portion by inserting a clipping pin 220 of the fastening clip 202A, 202B into the hole 216 of the movable frame member 102A, 102D and inserting a clipping pin 218 of the fastening clip 202A, 202B into one of the holes 212, 214 of the base frame member 102B, 102C.

The method 400 also comprises, at block 406, connecting the first and second segments to form a channel extending through the openings 502 of the first and second segments by connecting the distal connecting member 506 of the first segment to the proximal connecting member 504 of the second segment. The first and second segments may for example be connected after adjusting the extendable portions 508A-508D in block 404. In other examples, the extendable portions 508A-508D may be adjusted after connecting the first and second segments. The first and second segments may for example be similar to the segment 500 and may be connected by inserting the connector pins of the distal connecting member 506 of the first segment into the cutouts 504B of the proximal connecting member 504 of the second segment. In another example, the first and second segments may be similar to the cable carrier element 200 and may be connected by inserting the connector pins of the distal connecting member 228 on the clipping members 202A, 202B of the first segment into the cutouts of the proximal connecting member 226 on the clipping members 202A, 202B of the second segment.

The method 400 may be generalized to an arbitrary number of segments by repeating blocks 402 to 406 accordingly for each of the additional segments, e.g. to connect a third segment to the second segment and a fourth segment to the third segment. In some examples, the method 400 may be used to assemble a cable carrier comprising between 10 and 100 segments.

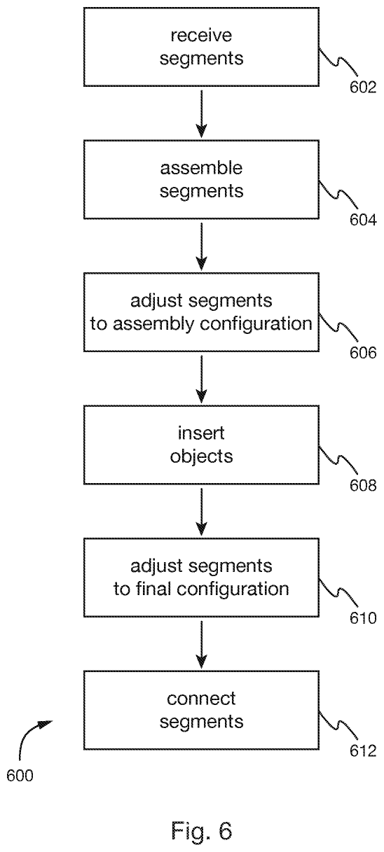

FIG. 6 depicts a flow chart of a method 600 of assembling a cable carrier from segments according to an example. The method 600 is similar to the method 400 and may for example also be used to assemble the cable carrier 316 of the printing device 300. The method 600 is described in the following using the cable carrier element 200 of FIGS. 2a-2c and the segment 500 of FIG. 5a, 5b as examples for the segments. In other examples, the segments may e.g. be similar to the cable carrier element 100. The method 600 is not limited to the order of execution indicated by the flow chart in FIG. 6. As far as technically feasible, the method 600 may be executed in an arbitrary order and parts thereof may be executed simultaneously at least in part.

The method 600 comprises, in block 602, receiving a first segment and a second segment similar to block 402 of method 400. In this example, the segments are received in a disassembled state, e.g. by receiving the frame members 102A-102D and/or the clipping members 202A, 202B as individual parts.

The method 600 may further comprise, in block 604, assembling the first and second segments. This may for example comprise inserting the pins 204 into the cutouts 206, e.g. by inserting the head portion 204B through the insertion portion 206A and subsequently moving the pin 204 to the first or second holding portion 206C. 206E. In some examples, block 604 may also comprise attaching one or both of the fastening pins or clipping members 202A, 202B to one or both of the respective frame members 102A-102D, e.g. by inserting the clipping pins 218 and/or 220 into the holes 212, 214 and/or 216.

The method 600 may further comprise, in block 606, for each of the first and second segments, adjusting the width and the height of the opening 502 to an assembly configuration by adjusting the respective extendable portions 508A-508D. At least one of the width and the height of the opening 502 is larger in the assembly configuration than in the final configuration. In one example, each of the extendable portions 508A-508D may be at the respective maximum length in the assembly configuration. This may facilitate inserting objects into the opening 502 in the assembly configuration while prevent the objects from moving or bending within the opening 502 in the final configuration.

When using the element 200, the pins 204 may e.g. be arranged in the first holding portion 206C or in the insertion portion 206A of the slot 206 in the assembly configuration. The clipping pins 218, 220 of the clipping members 202A, 202B may e.g. be arranged in the holes 214 and 216, respectively, in the assembly configuration. In some examples, the clipping pins 218 and/or 220 may not be inserted in the respective holes in the assembly configuration, e.g. such that the frame members 102A, 102D can be moved freely relative to the frame members 102B, 102C, for example to open the hollow core of the cable carrier for inserting objects therein.

The method 600 may further comprise, at block 608, inserting the objects to be arranged in the cable carrier into the openings 502 of the first and second segment. In some examples, the objects may be inserted into the openings 502 in the assembly configuration prior to adjusting the width and the height of the openings 502 to the final configuration. In some examples, the objects may be inserted into the openings 502 prior to connecting the first and second segments in block 612 (see below). In other examples, the objects may be inserted into the openings 502 after connecting the first and second segments, i.e. may be threaded through the hollow core of the assembled cable carrier. The objects may for example comprise a flexible connecting member such as a cable and/or a tube, e.g. the cable 308 and the tube 312 of the printing device 300.

Subsequently, the width and the height of the openings 502 may be adjusted to the final configuration in block 610, which may be similar to block 404 of method 400. When using the element 200, the pins 204 may e.g. be moved from the first holding portion 206C or from the insertion portion 206A of the slot 206 to the second holding portion 206E as the final configuration to reduce the width of the opening 102. Additionally or alternatively, the bottom clipping pins 218 of the clipping members 202A, 202B may e.g. be inserted into the lower holes 212 as the final configuration to reduce the height of the opening 102.

In block 612, the first and second segments are connected to each other, e.g. similar to block 406 of method 400. In some examples, this may also comprise connecting the second segment to a moveable carriage of a printing device, e.g. a print head carriage. This may further comprise connecting the objects arranged in the cable carrier to the moveable carriage, e.g. the cable 308 and the tube 312.

The description is not intended to be exhaustive or limiting to any of the examples described above. The element for a cable carrier, the printing device and the method of assembling a cable carrier from segments disclosed herein can be implemented in various ways and with many modifications without altering the underlying basic properties.

1. An element for a cable carrier, the element comprising a frame surrounding an opening that is to receive a cable or a tube, or a bundle of cables or tubes, wherein
the frame comprises four frame members, wherein pairs of adjacent frame members form U-shaped portions of the frame;
a right-hand side U-shaped portion is adjustably engaged with a left-hand side U-shaped portion such that the respective U-shaped portions are movable relative to each other along a first direction to vary a cross-sectional area of the opening; and
a bottom U-shaped portion is adjustably engaged with a top U-shaped portion such that the respective U-shaped portions are movable relative to each other along a second direction perpendicular to the first direction to vary the cross-sectional area of the opening.

2. The cable carrier element of claim 1, wherein:
each of the frame members of the right-hand side U-shaped portion comprises a pin; and
each of the frame members of the left-hand side U-shaped portion comprises a slot that extends along the first direction and is to receive the pin of the respective frame member of the right-hand side U-shaped portion.

3. The cable carrier element of claim 2, wherein:
each of the pins comprises a shaft portion having a shaft diameter and a head portion having a head diameter larger than the shaft diameter;
each of the slots comprises an insertion portion, a first intermediate portion, a first holding portion, a second intermediate portion and a second holding portion arranged along the first direction;
a width of the insertion portion is larger than the head diameter;
a width of the first and second holding portions is equal to or larger than the shaft diameter and smaller than the head diameter; and
a width of the first and second intermediate portions is smaller than the shaft diameter.

4. The cable carrier element of claim 1, wherein:
each of the frame members of the bottom U-shaped portion comprises two pairs of holes, wherein the pairs are displaced from each other along the second direction;
each of the frame members of the top U-shaped portion comprises one pair of holes; and
each of the holes is to receive a clipping pin.

5. The cable carrier element of claim 4, wherein:
the element further comprises a left-hand side clipping member and a right-hand side clipping member;
each of the clipping members comprises a bottom pair of clipping pins and a top pair of clipping pins;
the top pair of clipping pins is to be inserted into the pair of holes of the respective frame member of the top U-shaped portion; and
the bottom pair of clipping pins is to be inserted into one of the pairs of holes of the respective frame member of the bottom U-shaped portion.

6. The cable carrier element of claim 5, wherein:
the element further comprises a proximal connector and a distal connector;
the proximal connector is to be connected to a distal connector of a proximally adjacent element for assembling the cable carrier; and
the distal connector is to be connected to a proximal connector of a distally adjacent element for assembling the cable carrier.

7. The cable carrier element of claim 6, wherein:
the proximal connector comprises a cutout in each of the left-hand side and right-hand side clipping members;
the distal connector comprises a connector pin in each of the left-hand side and right-hand side clipping members; and
the connector pin is to be inserted into the cutout of a respective clipping member of an adjacent element.

8. The cable carrier element of claim 1, wherein
at least one of the frame members comprises a guiding rail that extends along the first direction and is to receive a guiding protrusion of one of the other frame members; and
at least one of the frame members comprises a guiding rail that extends along the second direction and is to receive a guiding protrusion of one of the other frame members.

9. A printing device comprising:
a movable carriage that is to be moved along at least one direction;
a flexible connecting member, wherein a distal end of the flexible connecting member is attached to the movable carriage; and
a cable carrier comprising a plurality of segments that are linked to each other to form a chain of segments having a hollow core extending along a longitudinal direction, wherein the flexible connecting member is arranged in the hollow core,
wherein each of the segments:
comprises four members forming a frame around the hollow core;
is adjustable along a first transverse direction perpendicular to the longitudinal direction by moving a first member and a second member relative to a third member and a fourth member, wherein the second member is adjacent to the first member and the fourth member is adjacent to the third member; and
is adjustable along a second transverse direction perpendicular to the longitudinal direction and to the first transverse direction by moving the first member and the fourth member relative to the second member and the third member, wherein the fourth member is adjacent to the first member and the third member is adjacent to the second member.

10. The printing device of claim 9, wherein the moveable carriage is a print head carriage that is to receive a print head and the flexible connecting member comprises a cable or a tube, or a bundle of cables or tubes, connected to the print head carriage.

11. A method of assembling a cable carrier from segments, wherein:
each of the segments encloses a respective opening and comprises a proximal connecting member and a distal connecting member;
each of the segments further comprises four extendable portions, wherein the four extendable portions are arranged on four sides of the opening;
two opposite extendable portions are to be moved from a first length to a second length to adjust a width of the opening; and
the other two opposite extendable portions are to be moved from a third length to a fourth length to adjust a height of the opening,
the method comprising:
receiving a first segment and a second segment;
for each of the first and second segments, adjusting the width and the height of the respective opening to a final configuration by adjusting the respective extendable portions based on a cross-sectional area of objects to be arranged in the cable carrier; and
connecting the first and second segments to form a channel extending through the openings of the first and second segments by connecting the distal connecting member of the first segment to the proximal connecting member of the second segment.

12. The method of claim 11, further comprising:
for each of the first and second segments, adjusting the width and the height of the opening to an assembly configuration by adjusting the respective extendable portions, wherein at least one of the width and the height of the opening is larger in the assembly configuration than in the final configuration; and
inserting the objects to be arranged in the cable carrier into the openings of the first and second segment in the assembly configuration prior to adjusting the width and the height of the openings to the final configuration.

13. The method of claim 11, wherein each of the extendable portions of the segments for adjusting the width comprises a frame member having a pin and a frame member having a longitudinal cutout that is to movably receive the pin, the method further comprising:
assembling each of the first and second segments by inserting the pins into the respective cutouts,
wherein adjusting the width of the openings of the first and second segments comprises moving the respective pins along the cutouts.

14. The method of claim 13, wherein each of the extendable portions of the segments for adjusting the height comprises:
a base frame member having two holes; and
a movable frame member having one hole,
wherein adjusting the height of the openings of the first and second segments comprises for each of the respective extendable portions:
moving the movable frame member relative to the base frame member; and
attaching a fastening clip to the respective extendable portion by inserting a clipping pin of the fastening clip into the hole of the movable frame member and inserting a clipping pin of the fastening clip into one of the holes of the base frame member.

15. The method of claim 11, further comprising connecting the second segment to a print head carriage of a printing device.
